(19) United States
(12) Patent Application Publication
(10) Pub. No.: US 2002/0134969 A1
(43) Pub. Date: Sep. 26, 2002

(54) Internal mold release agent for low cost composite bipolar plates

(76) Inventors: Jeremy R. Chervinko, Elk Grove, IL (US); Qinbai Fan, Chicago, IL (US); Michael Onischak, St. Charles, IL (US); Leonard G. Marianowski, Mt. Prospect, IL (US)

Correspondence Address: Mark E. Fejer, Pauley Petersen Kinne & Fejer, Suite 365, 2800 West Higgins Road, Hoffman Estates, IL, 60195, US

(21) Appl. No.: 09/783,523

(22) Filed: Feb. 14, 2001

(51) Int. Cl. H01B 1/06; H01M 8/02

(52) U.S. Cl. 252/511; 429/34; 264/241

(57) ABSTRACT

A composition of electrically conducting carbon/graphite particles, a bonding agent and a mold release agent and a method employing the composition for producing a bipolar plate for a polymer electrolyte membrane fuel cell in which the composition is introduced into a mold suitable for compression molding the bipolar plate and pressed in the mold at a temperature sufficient to melt the bonding agent and activate the mold release agent, thereby forming the bipolar plate. The mold release agent acts to prevent sticking of the bipolar plate to the mold. In accordance with one preferred embodiment, the mold release agent is a mixture of at least one fatty acid and at least one polyolefin.

### BACKGROUND OF THE INVENTION

1. Field of the Invention

This invention relates to a method for compression molding of bipolar plates for polymer electrolyte membrane (PEM) fuels cells. More particularly, this invention relates to a method and means for promoting the release of a molded bipolar plate from the mold which addresses the problem of adherence of the molded bipolar plate to the mold after completion of the compression molding operation.

2. Description of Prior Art

In a fuel cell stack comprising a plurality of individual fuel cell units, each of which comprises an anode electrode, a cathode electrode and an electrolyte disposed between the anode electrode and the cathode electrode, a bipolar plate or bipolar separator plate is disposed in the fuel cell stack between the anode electrode of one fuel cell unit and the cathode electrode of an adjacent fuel cell unit and provides for distribution of the reactant gases to the anode electrode and the cathode electrode. Typically, the bipolar plate comprises a centrally disposed active region having a plurality of channels or other structural features for distributing the reactant gases across the surfaces of the electrodes.

In a polymer electrolyte membrane fuel cell, the electrolyte is a thin ion-conducting membrane such as NAFION®, available from DuPont. The bipolar plates are frequently made of a mixture of electrically conducting carbon/graphite particles which have been compression molded into the desired shape. Bipolar plates suitable for use in PEM fuel cells are taught, for example, by U.S. Pat. No. 5,942,347 which is incorporated herein by reference in its entirety.

In addition to electrically conducting carbon/graphite particles, suitable bipolar plates comprise other additives including a binding or bonding agent, such as an organic resin that causes the carbon/graphite particles to adhere to each other upon reaching the molding temperature, at which temperature the resin melts to form a liquid phase that becomes the binding or bonding agent. Unfortunately, in addition to enabling the carbon/graphite particles to adhere to one another, the formation of this liquid phase also bonds or adheres to the mold surface, thereby causing the molded parts to fracture or crack during attempts to free them from the mold. One possible solution to this problem is to coat the surface of the mold prior to each molding operation with a material which prevents the bonding or adherence. The undesirability of this solution in terms, for example, of the additional equipment required to apply the coating, ensuring that the mold is completely coated before each molding operation, and the amount of additional time required to mold each part are apparent. In addition, build-up of release agent and transfer to the molded part are also problems.

U.S. Pat. Nos. 5,582,622, 5,582,937, 5,556,627 and 5,536,598, all to LaFollette, teach bipolar plates comprising carbon and one or more fluoroelastomers which provide improved mold release characteristics. U.S. Pat. No. 4,900,698 to Lundsager teaches a method for producing porous ceramic products in which a metal and ceramic filler are bound together with a clean burning polyolefin and a plasticizer and molded into a final shape. Thereafter the plasticizer is removed to introduce porosity into the shaped article. The article is heated to decompose the polyolefin which can exit as a gas through the pore openings. Aluminum powder is added to the mixture to improve release of the ceramic green bodies from the dies or molds.

### SUMMARY OF THE INVENTION

It is one object of this invention to provide a method for compression molding of bipolar plates for PEM fuel cells which provides for substantially complete release of the molded plate after completion of the compression molding operation.

It is another object of this invention to provide a method for compression molding of bipolar plates for PEM fuel cells which eliminates the need for coating of the mold prior to molding of each plate.

It is another object of this invention to provide a method for compression molding of bipolar plates for PEM fuel cells which permits increases in production speed compared to conventional compression molding methods.

These and other objects of this invention are addressed by a method for producing a bipolar separate plate for a PEM fuel cell in which a mixture comprising electrically conducting carbon/graphite particles, a particle bonding agent and a mold release agent is formed. The mixture is introduced into a mold suitable for compression molding of the bipolar plate and pressed at a temperature sufficient to melt the bonding agent and activate the mold release agent, thereby forming the bipolar plate.

In contrast to conventional compression molding methods for compression molding of bipolar plates for PEM fuel cells, the method of this invention employs an internal mold release agent which acts to prevent the bipolar plate materials from adhering to the mold. Because the internal mold release agent is mixed directly into the mixture of carbon/graphite particles and bonding agent, there is no delay between individual compression molding operations as in conventional methods where a coating must be applied to the mold between each compression molding operation. As a result, the compression molding speed can be increased from about 5 plates per hour to about 25 plates per hour.

### DESCRIPTION OF PREFERRED EMBODIMENTS

The invention disclosed herein is a composition and a method employing the composition for producing bipolar plates for PEM fuel cells. The composition comprises an internal mold release agent which promotes the quick release of a molded plate from the mold in which it was formed. By the term “internal mold release agent”, we mean a component of the mixture used to produce bipolar plates which is activated from within the mixture to promote quick release of the molded plate (as compared to an “external mold release agent” which is applied external to the mixture, such as the application of a coating to the mold surfaces before each molding operation).

Accordingly, the composition in accordance with one embodiment of this invention for producing a bipolar plate for a PEM fuel cell comprises electrically conducting particles of carbon and graphite, a bonding agent suitable for adhering the electrically conducting carbon and graphite particles together upon compression molding of the composition, and an internal mold release agent which promotes separation of the mold from the bipolar plate upon completion of the compression molding operation. In accordance with one particularly preferred embodiment of this invention, the internal mold release agent comprises a mixture of at least one fatty acid and at least one polyolefin, which mixture comprises in the range of about 0.5% to about 1.0% by weight of the composition. A preferred bonding agent for use in the composition of this invention is an organic resin which forms a liquid phase upon reaching the temperature at which the compression molding is carried out.

Use of the internal mold release agent in accordance with this invention enables a five-fold increase in the rate of plate production over conventional compression molding. In particular, the internal mold release agent eliminates the need to apply an external mold release agent between each compression step, thereby increasing productivity.

Without intending to be bound by any one explanation as to the operating mechanism of the internal mold release agent, it is believed that, during the compression molding operation, which is carried out at elevated temperature, the internal mold release agent accumulates between the interface of the molded bipolar plate and the mold, preventing significant contact between the molded plate and the mold surface, and then evaporates, primarily after the bipolar plate is released from the mold at the mold temperature.

In the method of this invention for producing a bipolar plate for a polymer electrolyte membrane fuel cell, a mixture of electrically conducting carbon/graphite particles, a bonding agent and a mold release agent is formed and introduced into a mold suitable for compression molding the bipolar plate. The mixture is pressed in the mold at a temperature sufficient to melt the bonding agent and activate the mold release agent, thereby forming the bipolar plate which is readily removable from the mold without sticking. Optionally, after completion of the pressing step, the surfaces of the resulting bipolar plate are subjected to liquid honing to promote as low a surface resistance on the plates as possible. In accordance with one preferred embodiment of this invention, the bonding agent comprises an organic resin and the mold release agent comprises a mixture of at least one fatty acid and at least one polyolefin. The concentration of internal release agent disposed in the mixture is preferably in the range of about 0.5% by weight to about 1.0% by weight. To further promote easy release of the bipolar plate from the mold upon completion of the compression process, the molds into which the mixture is introduced are plated with a material selected from the group consisting of chrome, stainless steel and aluminum and the plated mold is coated with a solvent-based mold sealer. The sealer acts to close the pores in the mold surface, the porosity of which depends upon the type of metal used to plate the mold, so that the organic resin in the mixture cannot grab onto the mold. One suitable solvent-based mold sealer suitable for use in the method of this invention is Frekote Sealer B-15, available from Dexter Corporation.

The surface resistance on plates produced in accordance with the method of this invention is equal to the surface resistance of liquid honed plates produced with KRYTOX® TEFLON®, available from Miller-Stephenson Chemical Company, Inc. As a result, the post-operation step of liquid honing may not be necessary. However, if some of the internal mold release agent remains on the surface of the plates, the surface resistance of the plate increases, which would necessitate the post-operation step of liquid honing.

### EXAMPLE

A mixture of 85% by weight graphite (SPG-87 available from Superior Graphite), 9.5% by weight of an organic resin (Plenco 12228 available from Plastic Engineering Company), 5% carbon (Vulcan XC-72R available from Cabot Corporation) and 0.5% by weight of an internal mold release agent (Axel INT-325PWD, a mixture of fatty acids and polyolefins available from Axel Plastic Research Laboratories, Inc.) was formed and introduced into a mold. The mixture was pressed at temperatures in the range of about 350° F. to about 400° F. at a pressure of about 3700 psi for a period of time in the range of about 2 minutes to about 10 minutes to produce the bipolar plate.

To determine if any contaminants which might be harmful to the membrane/electrode assembly remained in the plates made with Axel INT-325PWD, a leachate test was conducted in 80° C. water. The only contaminant detected was zinc ions, but only in small quantities (<0.5 ppm). At this low concentration, the membrane/electrode assembly is considered to be safe from harm. In addition, the leaching of zinc was found to be a temporary condition, not extending beyond about 40 hours. In the event that contaminants do remain on the plates after completion of the molding process, placement of the plates in warm water may be used as a means for removing such contaminants.

Table 1 hereinbelow shows a comparison between plates produced using compositions with and without an internal mold release agent. As can clearly be seen, the performance of bipolar plates produced in accordance with this invention (Plate ID 2) is generally comparable to or better than the performance of plates produced more conventionally, that is without the use of an internal mold release agent (Plate ID 1). For example, flexural strength of plates produced in accordance with the method of this invention is improved over plates produced by more conventional means.

TABLE 1

| | | | | | | Bulk | Surface | Flexural |
|---|---|---|---|---|---|---|---|---|
| Plate | Composition | | | | Density | Conductivity | Resistance | Strength |
| ID | Graphite | Resin | Carbon | Other | (g/cc) | (S/cm) | (mΩ) | (PSI) |
| 1 | 85% | 10% | 5% | | 1.89 | 778 | 186 | 5000-7000 |
| | SPG-87 | Plenco | XC-72R | | | | | |
| | | 12228 | | | | | | |
| 2 | 85% | 9.0% | 4% | 1.0% | 1.89 | 747 | 220 | 6500-9000 |
| | SPG-87 | Plenco | XC-72R | Axel | | | | |
| | | 12228 | | 325 | | | | |

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

We claim:

1. A composition for producing a bipolar plate for a PEM fuel cell comprising:
electrically conducting particles of carbon and graphite, a bonding agent suitable for adhering the electrically conducting carbon and graphite particles together upon compression molding of the composition, and an internal mold release agent suitable for promoting separation of the mold from the bipolar plate upon completion of the compression molding operation.

2. A composition in accordance with claim 1, wherein said internal mold release agent comprises a mixture of at least one fatty acid and at least one polyolefin.

3. A composition in accordance with claim 2, wherein said mixture comprises in a range of about 0.5% to about 1.0% by weight of the composition.

4. A composition in accordance with claim 1, wherein said bonding agent comprises an organic resin which forms a liquid phase upon reaching a temperature at which the compression molding is carried out.

5. A method for producing a bipolar plate for a polymer electrolyte membrane fuel cell comprising the steps of:
forming a mixture comprising electrically conducting carbon/graphite particles, a bonding agent and a mold release agent;
introducing said mixture into a mold suitable for compression molding said bipolar plate;
pressing said mixture in said mold at a temperature sufficient to melt said bonding agent and activate said mold release agent, thereby forming said bipolar plate.

6. A method in accordance with claim 5, wherein said bonding agent comprises an organic resin.

7. A method in accordance with claim 5, wherein said mold release agent comprises a mixture of at least one fatty acid and at least one polyolefin.

8. A method in accordance with claim 5, wherein said mold release agent comprises in a range of about 0.5% to about 1% by weight of said mixture.

9. A method in accordance with claim 5, wherein said pressing of said mixture is performed at a temperature in a range of about 350° F. (175° C.) to about 400° F. (205° C.).

10. A method in accordance with claim 5, wherein said mold comprises a die plated with a material selected from the group consisting of chrome, stainless, aluminum and combinations thereof.

11. A method in accordance with claim 5, wherein said mold is coated with a mold sealer.

12. A method in accordance with claim 11, wherein said mold seaer is solvent-based.

13. A method in accordance with claim 5, wherein said mold release agent vaporizes at a temperature less than a melting temperature of said bonding agent.

14. A method in accordance with claim 5 further comprising soaking said bipolar plate in warm water for removal of contaminants which may be present in said bipolar plate.
